(19) United States
(12) Patent Application Publication
(10) Pub. No.: US 2018/0129038 A1
(43) Pub. Date: May 10, 2018

(54) Optical Device Substrate, Optical Device Substrate Manufacturing Method, and Optical Device

(71) Applicant: Point Engineering Co., Ltd., Asan-si (KR)

(72) Inventors: Seung Ho Park, Hwaseong-si (KR); Moon Hyun Kim, Asan-si (KR); Tae Hwan Song, Cheonan-si (KR)

(21) Appl. No.: 15/800,498

(22) Filed: Nov. 1, 2017

(30) Foreign Application Priority Data
Nov. 4, 2016 (KR) 10-2016-0146486

(51) Int. Cl. G02B 27/00

(52) U.S. Cl. CPC G02B 27/0006; G02B 7/00

(57) ABSTRACT

An optical device substrate includes a substrate body having a mounting space formed thereon, and a guide pattern laminated on the substrate body and configured to guide a cover for covering the mounting space.

### CROSS-REFERENCE TO RELATED PATENT APPLICATION

This U.S. non-provisional patent application claims priority under 35 U.S.C. § 119 of Korean Patent Application No. 10-2016-0146486 filed on Nov. 4, 2016 in the Korean Patent Office, the entire contents of which are hereby incorporated by reference.

### TECHNICAL FIELD

The present invention relates to an optical device substrate, an optical device substrate manufacturing method and an optical device and, more particularly, to an optical device substrate in which a guide pattern for guiding a cover which covers a mounting space is laminated on a substrate body, an optical device substrate manufacturing method and an optical device.

### BACKGROUND

In the related art, a space for mounting a chip on a chip base plate is formed by mechanically processing the upper surface of the chip base plate (using a tool). In the case of mounting an optical element chip on such a chip base plate, a space having a wide top and a narrow bottom is formed in order to enhance the light reflection performance. After forming such a space, the chip is mounted and the mounting space is covered with a glass. In order to stably install the glass on the chip base plate, a seating groove on which the glass is seated is formed in a circular shape on the upper surface of the chip base plate. Thus, the glass is also formed in a circular shape. However, from the viewpoint of manufacturing process, it is more difficult to accurately process the glass in a circular shape than to process the glass in a rectangular or triangular shape.

In order to solve such a problem, Korean Patent Application Publication No. 2016-0084652 discloses a configuration in which a groove for seating a rectangular glass is formed on a chip base plate. Inasmuch as such a groove is formed by machining, it is difficult to form the groove on a chip base plate having a small size.

### SUMMARY

According to one aspect of the present invention, there is provided an optical device substrate, including: a substrate body having a mounting space formed thereon; and a guide pattern laminated on the substrate body and configured to guide a cover for covering the mounting space.

According to another aspect of the present invention, there is provided an optical device substrate, including: a substrate body having a mounting space formed thereon; and a guide pattern formed on the substrate body separately from the substrate body and configured to guide a cover for covering the mounting space.

According to a further aspect of the present invention, there is provided an optical device substrate, including: a substrate body having a mounting space formed thereon; and two or more guide patterns formed on the substrate body in a spaced-apart relationship with each other and configured to guide a cover for covering the mounting space.

In the optical device substrate, the guide pattern may include a first portion and a second portion intersecting with the first portion.

In the optical device substrate, the guide pattern may be disposed on a corner of the substrate body.

In the optical device substrate, the substrate body may include a plurality of conductive layers disposed side by side and an insulating layer disposed between the conductive layers and configured to electrically separate the conductive layers, and the guide pattern may be formed on each of the conductive layers.

In the optical device substrate, the substrate body may include a plurality of conductive layers disposed side by side and an insulating layer disposed between the conductive layers and configured to electrically separate the conductive layers, and the guide pattern may be made of a material differing from a material of the conductive layers.

According to a further aspect of the present invention, there is provided an optical device substrate manufacturing method, including: a step of forming a substrate body; and a lamination step of laminating a guide pattern on the substrate body, wherein the guide pattern is configured to guide a cover for covering a mounting space formed on the substrate body.

In the method, the substrate body may be formed so as to include a plurality of conductive layers disposed side by side and an insulating layer disposed between the conductive layers and configured to electrically separate the conductive layers, the mounting space may be formed on the conductive layers and the insulating layer, and the guide pattern may be formed on the conductive layers.

The method may further include: a step of removing the guide pattern after the lamination step.

According to a further aspect of the present invention, there is provided an optical device substrate manufacturing method, including: a step of forming a substrate body; and a lamination step of laminating a pattern on the substrate body, wherein the pattern is disposed around a mounting space formed on the substrate body.

According to a further aspect of the present invention, there is provided an optical device, including: a substrate having a mounting space formed thereon; a chip mounted on the substrate and disposed inside the mounting space; and a cover configured to cover the mounting space, wherein a guide pattern configured to guide the cover is laminated on the substrate.

According to a further aspect of the present invention, there is provided an optical device, including: a substrate having a mounting space formed thereon; a chip mounted on the substrate and disposed inside the mounting space; a cover configured to cover the mounting space; and an adhesive agent configured to bond the cover to the substrate, wherein the cover has a smaller width than the substrate.

According to a further aspect of the present invention, there is provided an optical device, including: a substrate having a mounting space formed thereon; a chip mounted on the substrate and disposed inside the mounting space; a cover configured to cover the mounting space; and a guide pattern configured to guide the cover, wherein an outer end surface of the guide pattern is flush with an outer end surface of the substrate.

The optical device substrate, the optical device substrate manufacturing method and the optical device according to the present invention have the following effects.

The guide pattern for guiding the cover which covers the mounting space is laminated on the substrate body. This makes it possible to easily form the guide pattern even on the substrate having a small size. Due to the formation of such a guide pattern, it is possible to prevent an adhesive agent for bonding the cover to the substrate from overflowing out of a bonding region. Furthermore, by virtue of the formation of such a guide pattern, the position of the cover is guided so that the cover is not tilted (misaligned) with respect to the substrate when bonding the cover to the substrate. Accordingly, when cutting a unit substrate, the cover is prevented from being cut by a blade. This makes it possible to prevent the blade from being damaged. In addition, since the guide pattern can be finely formed, it is possible to maximize the contact area between the cover and the substrate body while minimizing the size of the substrate. This enables the cover to be strongly attached to the substrate body.

Since the guide pattern includes a first portion and a second portion intersecting with the first portion, it is possible to stably guide the cover with a simple structure.

The guide pattern is disposed in the upper portion of the corner of the substrate body. The substrate body is diced along the center of the guide pattern in the manufacturing process. It is therefore possible to simultaneously form the guide patterns of two substrates. This makes it easy to perform mass production.

### BRIEF DESCRIPTION OF THE DRAWINGS

FIG. 1 is a perspective view showing an optical device substrate according to a preferred embodiment of the present invention with a cover separated.

FIG. 2 is a plan view of the optical device substrate according to a preferred embodiment of the present invention.

FIG. 3 is a sectional view taken along line A-A in FIG. 2.

FIG. 4 is a bottom view of the optical device substrate according to a preferred embodiment of the present invention.

FIG. 5 is a plan view showing a mother plate from which the optical device substrate according to a preferred embodiment of the present invention is mass-produced.

FIG. 6 is a bottom view of the mother plate from which the optical device substrate according to a preferred embodiment of the present invention is mass-produced.

FIGS. 7 to 9 are plan views showing optical device substrates according to other embodiments of the present invention.

### DETAILED DESCRIPTION

Preferred embodiments of the present invention will now be described in detail with reference to the accompanying drawings.

For reference, the same configurations of the present invention as those of the related art will not be described in detail with the aforementioned related art referred to here.

When there is a description that a certain portion is positioned above another portion, it is meant that the certain portion may be positioned just above another portion or a third portion may be interposed between the certain portion and another portion. In contrast, when there is a description that a certain portion is positioned just above another portion, it is meant that a third portion is not interposed between the certain portion and another portion.

The terms used herein are intended to merely describe specific embodiments and are not intended to limit the present invention. The singular form used herein includes a plural form unless explicitly mentioned otherwise. The term “comprises” or “comprising” used herein is intended to specifically define a specific property, a region, an integer, a step, an operation, an element and/or a component and is not intended to exclude existence or addition of a specific property, a region, an integer, a step, an operation, an element and/or a component.

The terms indicating relative spaces such as “above”, “below” and the like may be used to more easily describe the relationship between one portion shown in the drawings and another portion. These terms are intended to include other meanings or operations of devices used together with the intended meanings in the drawings. For example, if the device in the drawings is inverted, a certain portion described to be positioned “below” another portion will be located “above” another portion. Therefore, the illustrative term “below” includes both an upper side and a lower side. A device may be rotated 90 degrees or at other angles. A term indicating a relative space is construed accordingly.

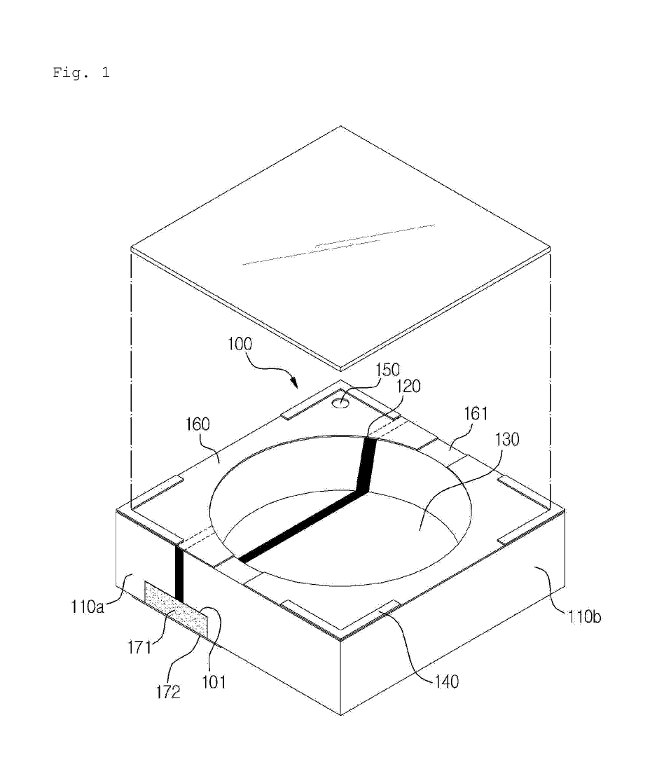

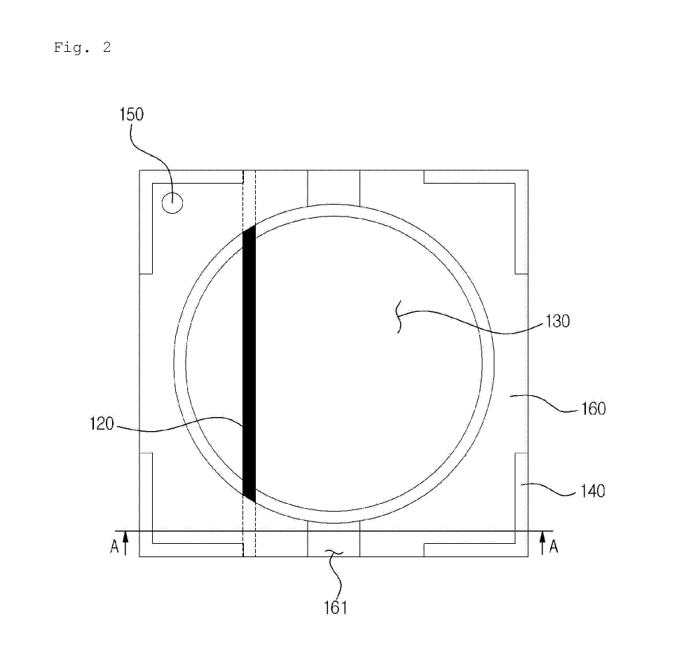

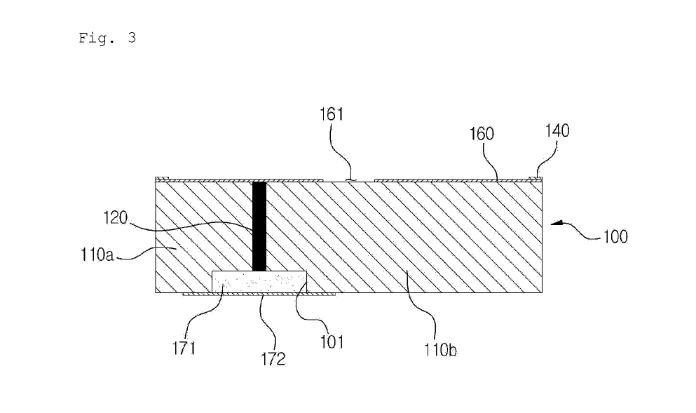

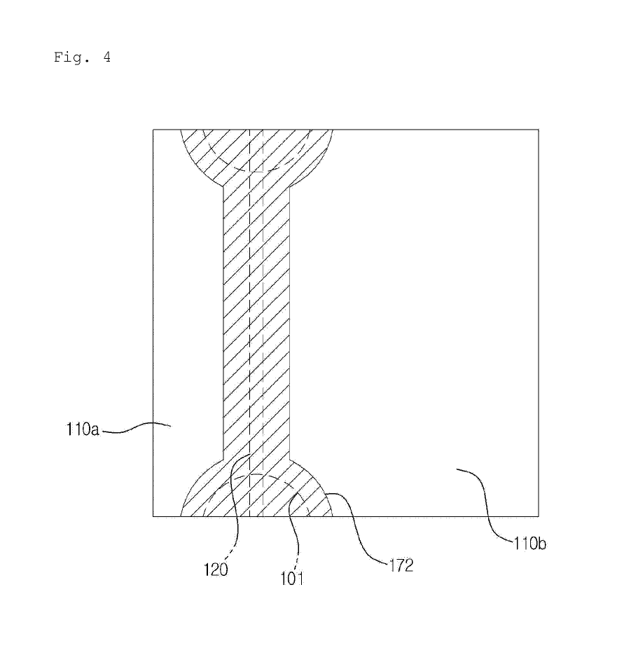

As shown in FIGS. 1 to 6, an optical device according to the present embodiment includes a substrate having a mounting space 130 formed thereon, a chip (not shown) disposed inside the mounting space 130 and mounted on the substrate, and a cover configured to cover the mounting space 130, wherein a guide pattern 140 configured to guide the cover is laminated on the substrate.

The substrate includes a substrate body 100 on which the mounting space 130 is formed. The guide pattern 140 is laminated on the substrate body 100.

The substrate body 100 includes a plurality of conductive layers arranged side by side, and an insulating layer 120 disposed between the conductive layers and configured to electrically separate the conductive layers.

The conductive layers include a first conductive layer 110a and a second conductive layer 110b. The first conductive layer 110a and the second conductive layer 110b are formed in a plate shape and are disposed in a left-right direction. The left-right width of the first conductive layer 110a is set to be smaller than the left-right width of the second conductive layer 110b.

The conductive layers are made of a metallic material such as aluminum or the like. The conductive layers are configured to apply a voltage to the chip (e.g., a light-emitting diode) mounted on the substrate body 100.

The insulating layer 120 is formed in a plate shape and is disposed between the first conductive layer 110a and the second conductive layer 110b.

In the present embodiment, there is described an example in which one insulating layer 120 exists between two conductive layers. However, the substrate body 100 may be formed by disposing two insulating layers between three conductive layers. Depending on the application, a larger number of insulating layers may be formed.

The substrate body 100 is formed in a rectangular parallelepiped shape with the front-rear length or the left-right length thereof larger than the height thereof.

The mounting space 130 in which the chip is mounted is formed on the upper surface of the substrate body 100. In other words, the mounting space 130 is formed so that the upper portion thereof is opened. The mounting space 130 may be formed so as to have a circular horizontal cross section.

The mounting space 130 may be formed to extend across the first conductive layer 110a, the second conductive layer 110b and the insulating layer 120. The mounting space 130 is formed so that the diameter thereof grows larger upward. In other words, the side wall defining the mounting space 130 is obliquely formed. The bottom surface defining the mounting space 130 is a flat surface.

A lamination layer 160 is laminated and formed on the upper surface of the substrate body 100. The laminating direction of the lamination layer 160 and the guide pattern 140 to be described later (the vertical direction) is orthogonal to the disposing direction of the insulating layer 120 and the conductive layers of the substrate body 100 (the left-right direction or the front-rear direction).

As described above, the lamination layer 160 is formed separately from the substrate body 100. The lamination layer 160 may be made of a metal such as nickel (Ni) or gold (Au), a photo resist, a solder resist, a photo solder resist or a dry film.

In this way, the lamination layer 160 is made of a conductive material or an insulating material. In the present embodiment, the lamination layer 160 is made of an insulating material. The lamination layer 160 is formed on the first conductive layer 110a, the insulating layer 120 and the second conductive layer 110b. In other words, the lamination layer 160 is formed around the mounting space 130.

In the case where the lamination layer 160 is made of a conductive material, the lamination layer 160 is not formed on the insulating layer 120 and is formed on only the first conductive layer 110a and the second conductive layer 110b. The lamination layer 160 formed on the upper surface of the first conductive layer 110a is separated and insulated by the insulating layer 120 from the lamination layer 160 formed on the upper surface of the second conductive layer 110b.

The lamination layer 160 is formed only in a part of the upper surface of the substrate body 100. The lamination layer 160 is formed on the entire upper surface of the insulating layer 120 and on a part of the upper surfaces of the first conductive layer 110a and the second conductive layer 110b.

As a result, grooves 161 connecting the mounting space 130 and the outside of the substrate body 100 are patterned in the lamination layer 160. Thus, the grooves 161 are formed in the upper portion of the substrate body 100. The grooves 161 are formed so as to communicate with the mounting space 130.

The lamination layer 160 may be formed by a plating method, a method of coating, exposing and developing a masking solution, or a method of attaching a dry film having a pattern formed thereon.

The grooves 161 are radially disposed around the mounting space 130. The grooves 161 may be disposed on the front and rear sides or the left and right sides of the mounting space 130. In the present embodiment, the grooves 161 are disposed on the front and rear sides of the mounting space 130. The grooves 161 thus disposed extend along a straight line.

The grooves 161 are disposed on the second conductive layer 110b of the conductive layers. The left-right width of the grooves 161 is set to be larger than the left-right width of the insulating layer 120.

When heating is performed in order to bond the cover to the substrate body 100 using a thermosetting adhesive agent (not shown), the grooves 161 allow the expanded air existing in the mounting space 130 to be discharged to the outside. This makes it possible to prevent the cover from being deformed or displaced. The thermosetting adhesive agent may be made of a silicon polymer material.

As described above, the grooves 161 are not formed directly on the conductive layers but are formed by adding a separate layer to the conductive layers and forming a pattern in the added layer. This makes it possible to easily form the grooves 161 even on a substrate having a small size. Furthermore, the grooves 161 may be simultaneously formed on a plurality of substrates. This facilitates mass production. It is also possible for the lamination layer 160 to protect the substrate body 100. After the cover is fixed, the grooves 161 are at least partially closed.

The guide pattern 140 for guiding the cover which covers the mounting space 130 is laminated on the substrate body 100. The cover may be made of a transparent material such as glass or quartz. In other words, the cover is made of a material different from the substrate body 100. The cover is formed in a polygonal shape such as a rectangular shape or the like and is formed in a flat plate shape.

In the present embodiment, the cover is bonded to the substrate in an individualized form. Thus, the horizontal cross-sectional area of the cover is set to be smaller than the horizontal cross-sectional area of the substrate body 100. Accordingly, the edge (outer end) of the cover is disposed inward of the edge of the substrate body 100. The width of the cover is smaller than the width of the substrate. Specifically, the front-rear width and left-right width of the cover is smaller than the front-rear width and left-right width of the substrate body 100 of the substrate.

The cover covers the upper portion of the mounting space 130, thereby preventing foreign materials from entering the mounting space 130. Furthermore, the cover covers at least a part of the upper portions of the grooves 161. The grooves 161 are disposed between the cover and the upper surface of the substrate body 100. The cover is bonded to the upper portion of the substrate body 100 by a thermosetting adhesive agent or the like.

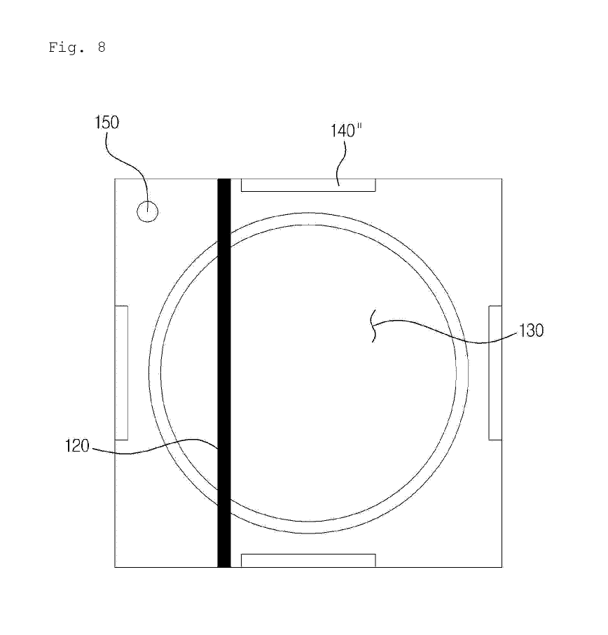

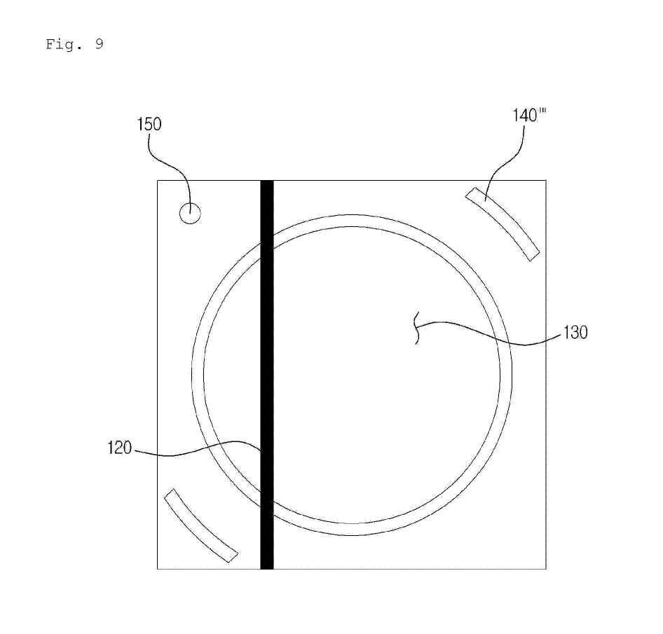

The guide pattern 140 is laminated on the lamination layer 160. Accordingly, the guide pattern 140 is formed separately from the substrate body 100. The guide pattern 140 is disposed on the first conductive layer 110a and the second conductive layer 110b. Alternatively, when the cover is bonded to the substrate body 100 by an adhesive agent such as an ultraviolet-curable adhesive agent or the like that does not expand the air in the mounting space 130 in the process of curing the adhesive agent, it is not necessary to form the grooves 161. Therefore, as shown in FIGS. 8 and 9, the guide pattern 140″ or 140′″ may be formed directly on the substrate body 100.

Accordingly, the guide pattern 140 is formed so as to protrude more upward than the adjacent other portions. The guide pattern 140 is disposed around the mounting space 130. The guide pattern 140 is disposed so as to be spaced apart outward from the mounting space 130. The guide pattern 140 is formed of a photo resist, a solder resist or a dry film.

The guide pattern 140 may be formed by a method of coating, exposing and developing a masking solution or a method of bonding a dry film having a pattern formed thereon.

The guide pattern for positioning the cover when bonding the cover to the substrate body 100 may is not formed directly on the substrate body 100 but is formed by laminating a layer on the substrate body 100. This makes it possible to easily form the guide pattern 140 even on a substrate having a small size.

The guide pattern 140 may be removed in the process of cutting the substrate body 100. In this case, the upper surface of the cover in the final product of the optical device protrudes above the uppermost surface of the substrate. More specifically, the upper surface of the edge of the cover is disposed above the uppermost surface of the portion of the substrate disposed outside the cover.

The adhesive agent for bonding the cover to the substrate body 100 is injected around the mounting space 130 so as to be disposed inside the guide pattern 140. The adhesive agent existing inside the guide pattern 140 is disposed on the lower portion and the side portion of the cover. In other words, the adhesive agent is disposed between the cover and the substrate body 100 and between the cover and the guide pattern 140.

The guide pattern 140 may serve as a dam for preventing the adhesive agent from overflowing out of a bonding region. However, the adhesive agent may overflow out of the bonding region in the portion of the upper surface of the substrate body 100 where the guide pattern 140 is not formed (the portion existing between two guide patterns). The adhesive agent may have at least one protrusion portion protruding more outward than the remaining portions (non-overflowing portions). The protrusion portion protrudes more outward than the cover.

The guide pattern 140 is made of a material differing from a material of the substrate body 100 on which the guide pattern 140 is formed. In other words, the guide pattern 140 is made of a material differing from a material of the conductive layers.

There may be formed two or more (e.g., four) guide patterns 140 which are spaced apart from one another. At least two of the guide patterns 140 are disposed so as to face each other. The guide patterns 140 are disposed on a diagonal line. The guide patterns 140 are disposed are respectively disposed outside the respective sides of the cover. In addition, the guide patterns 140 are disposed on the front-rear sides and the left-right sides of the cover.

The guide pattern 140 includes a first portion and a second portion intersecting with the first portion. Each of the first portion and the second portion has a linear shape. An angle between the first portion and the second portion is 90 degrees. This means that the guide pattern 140 has a substantially L-like shape.

The guide pattern 140 is formed so as to surround the corner portion of the cover. The guide pattern 140 is disposed above the corner of the substrate body 100. In the present embodiment, a plurality of guide patterns 140 is provided above the respective corners of the substrate body 100.

When manufacturing an optical device, a mother plate (described later) may be diced (cut) along the centers of the guide patterns 140. This makes it possible to simultaneously form the guide patterns 140 of two substrates. This facilitates mass production. The guide patterns 140 are disposed so as to be spaced apart from the grooves 161. In other words, the guide patterns 140 are not formed on the grooves 161.

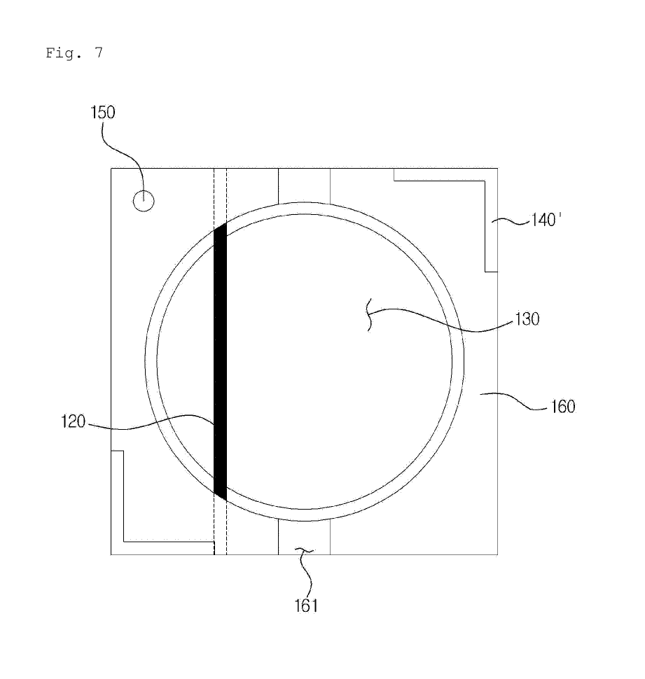

Alternatively, as shown in FIG. 7, the guide patterns 140′ having a substantially L-like shape may be formed only on the front left side and the rear right side on the upper surface of the substrate body. In other words, the guide patterns 140′ may be formed only on a single diagonal line of the cover. Alternatively, as shown in FIG. 8, the guide patterns 140″ having a straight line shape may be disposed on the outer side of the respective side surfaces of the cover on the upper surface of the substrate body. Alternatively, as shown in FIG. 9, when the cover is formed in a circular shape, the guide patterns 140′″ having an arc shape may be disposed radially outward of the cover on the upper surface of the substrate body.

A first mark 150 indicating that, for example, a negative voltage is applied to the first conductive layer 110a may be formed only on the first conductive layer 110a. This makes it possible to easily determine the polarity of the first conductive layer 110a. The first mark 150 is formed on the upper surface of the lamination layer 160.

A bur preventing groove 101 having a predetermined depth is formed on the lower surface of the substrate body 100 at the point where a cutting line intersects with the insulating layer 120 when longitudinally and vertically cutting the substrate body 100. The bur preventing groove 101 is formed so that the insulating layer 120 is exposed inside the bur preventing groove 101.

The bur preventing groove 101 is formed so that at least a part of the insulating layer 120 exposed on the lower surface of the substrate body 100 is accommodated inside the bur preventing groove 101. The horizontal cross section of the bur preventing groove 101 has a semicircular shape. The bur preventing groove 101 is formed so that the insulating layer 120 is disposed at the center of the bur preventing groove 101.

A liquid insulating material 171 is coated and cured inside the bur preventing groove 101. A solder resist layer 172 is additionally formed on the lower surfaces of the liquid insulating material 171, the insulating layer 120, the first conductive layer 110a and the second conductive layer 110b. This makes it possible to significantly reduce the possibility of generation of short-circuiting due to burrs. The left-right width of the solder resist layer 172 is set to be larger than the left-right width of the liquid insulating material 171 and the insulating layer 120.

A optical device substrate manufacturing method for manufacturing the optical device substrate configured as above will now be described.

The optical device substrate manufacturing method according to the present embodiment includes a step of forming a substrate body 100 and a lamination step of laminating a guide pattern 140 on the substrate body 100, wherein the guide pattern 140 is configured to guide a cover for covering a mounting space 130 formed in the substrate body 100.

As described above, the substrate body 100 is formed to include a plurality of conductive layers arranged side bay side and an insulating layer 120 alternately disposed with respect to the conductive layers and configured to electrically separate the conductive layers. The method of forming the substrate body 100 by alternately disposing the conductive layers and the insulating layer 120 is as follows.

A plurality of conductive plates (conductive layers) and a plurality of insulating layers 120 for electrically insulating the conductive plates are alternately laminated and bonded to one another. A conductive material lump having a plurality of insulating layers 120 spaced apart at regular intervals is manufactured by heating and pressing the conductive plates (conductive layers) and the insulating layers 120 alternately laminated. The substrate body 100 having the insulating layer 120 disposed between the conductive layers is formed by cutting the conductive material lump thus manufactured.

A mounting space 130 is formed on the upper surface of the substrate body 100 by machining or the like. The mounting space 130 is formed so as to extend across the first conductive layer 110a, the second conductive layer 110b and the insulating layer 120. The mounting space 130 may be formed after forming a lamination layer and a guide pattern to be described later. A bur preventing groove 101 is formed on the lower surface of the substrate body 100.

The optical device substrate manufacturing method further includes a step of laminating and forming a lamination layer 160 on the substrate body 100 (on the upper surface of the substrate body 100) before forming the guide pattern 140.

The lamination layer 160 may be laminated on the substrate body 100 by printing, coating, dispensing, vapor-depositing, bonding or other methods. When the lamination layer 160 is formed by a metallic material, it may be possible to use an e-beam or vapor deposition.

The lamination layer 160 is formed only in a part of the substrate body 100. Grooves 161 for connecting the mounting space 130 and the outside of the substrate body 100 are formed in the lamination layer 160. The grooves 161 are formed in the portions of the substrate body 100 where the lamination layer 160 is not formed. In other words, a pattern of the grooves 161 for connecting the mounting space 130 and the outside of the substrate body 100 is formed in the lamination layer 160. Different portions of the lamination layer 160 are spaced apart from each other by the mounting space 130 and the grooves 161.

The grooves 161 are disposed around the mounting space 130. The grooves 161 are formed so as to be disposed on the second conductive layer 110b of the conductive layers.

A guide pattern 140 is laminated on the substrate body 100. In the present embodiment, the guide pattern 140 is laminated on the lamination layer 160 existing on the substrate body 100. The guide pattern 140 may be laminated on the lamination layer 160 by printing, coating, dispensing, vapor-depositing, bonding, or other methods. When the guide pattern 140 is formed by a metallic material, it may be possible to use an e-beam or vapor deposition.

The guide pattern 140 is configured to guide the cover for covering the mounting space 130 formed in the substrate body 100. The guide pattern 140 is disposed on each of the corners of the substrate body 100 and is formed on each of the first conductive layer 110a and the second conductive layer 110b. The guide pattern 140 is disposed around the mounting space 130.

In this way, the grooves 161 or the patterns such as the guide pattern 140 or the like are formed on the substrate body 100. This makes it possible to easily form the grooves 161 or the guide pattern 140 even on the substrate body 100 having a small size.

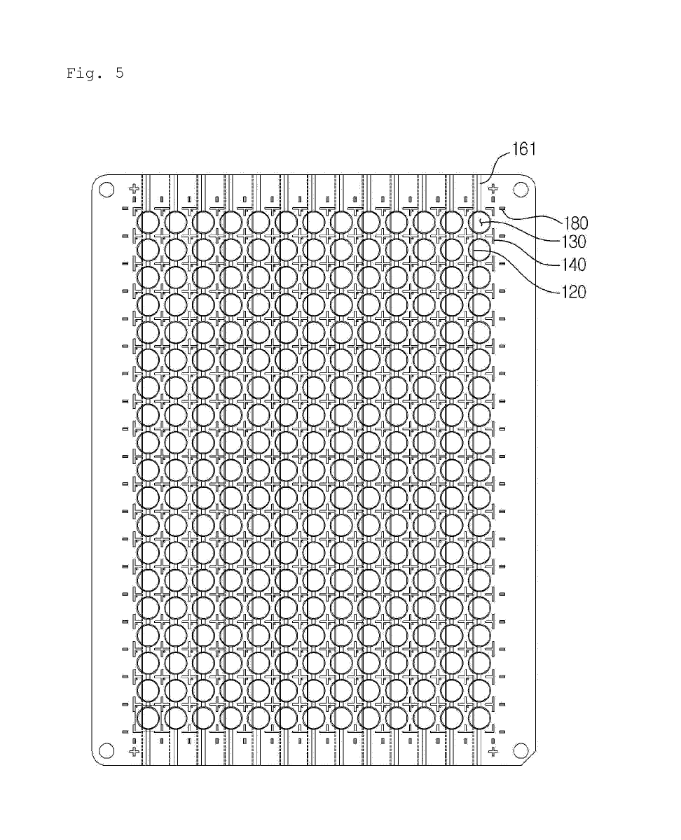

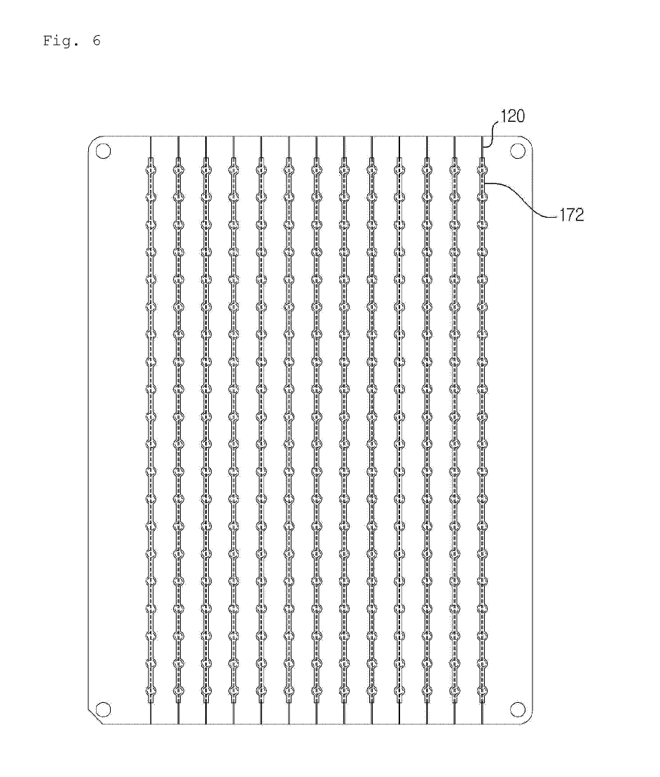

Referring to FIGS. 5 and 6, a mother plate for simultaneously forming a large number of substrate bodies 100 is formed by alternately laminating a plurality of conductive layers and a plurality of insulating layers 120. A plurality of mounting spaces 130 is formed on the mother plate. In the aforementioned manner, the grooves 161 and the guide pattern 140 are formed on the mother plate. One guide pattern 140 is integrally formed with another guide pattern of the adjacent substrate body 100. Individual substrate bodies are formed by cutting the mother plate along the center of the integrally formed guide pattern. Thus, the outer end surface of the guide pattern 140 is flush with the outer end surface of the substrate body 100. The grooves 161 are also integrally formed with the grooves of the adjacent substrate body 100.

After forming the guide pattern 140, an adhesive agent is injected toward the inner side of the guide pattern 140, thereby bonding the cover to the substrate body 100.

Then, the grooves 161 are filled before cutting the mother plate, so that water supplied in the cutting process does not flow into a gap between the cover and the substrate body 100.

Second marks 180 that indicate cutting lines are formed along the edge of the mother plate. The guide pattern 140 may be removed while cutting the mother plate after bending the cover to the substrate body 100.

While preferred embodiments of the present invention have been described above, the present invention is not limited to the aforementioned embodiments. It goes without saying that a person skilled in the relevant art may make various changes and modifications without departing from the spirit and scope of the invention defined in the claims.

What is claimed is:

1. An optical device substrate, comprising:
a substrate body having a mounting space formed thereon; and
a guide pattern laminated on the substrate body and configured to guide a cover for covering the mounting space.

2. An optical device substrate, comprising:
a substrate body having a mounting space formed thereon; and
a guide pattern formed on the substrate body separately from the substrate body and configured to guide a cover for covering the mounting space.

3. An optical device substrate, comprising:
a substrate body having a mounting space formed thereon; and
two or more guide patterns formed on the substrate body in a spaced-apart relationship with each other and configured to guide a cover for covering the mounting space.

4. The optical device substrate of claim 1, wherein the guide pattern includes a first portion and a second portion intersecting with the first portion.

5. The optical device substrate of claim 1, wherein the guide pattern is disposed on a corner of the substrate body.

6. The optical device substrate of claim 1, wherein the substrate body includes a plurality of conductive layers disposed side by side and an insulating layer disposed between the conductive layers and configured to electrically separate the conductive layers, and the guide pattern is formed on each of the conductive layers.

7. The optical device substrate of claim 1, wherein the substrate body includes a plurality of conductive layers disposed side by side and an insulating layer disposed between the conductive layers and configured to electrically separate the conductive layers, and the guide pattern is made of a material differing from a material of the conductive layers.

8. An optical device, comprising:
a substrate having a mounting space formed thereon;
a chip mounted on the substrate and disposed inside the mounting space; and
a cover configured to cover the mounting space,
wherein a guide pattern configured to guide the cover is laminated on the substrate.

9. The optical device of claim 8, further comprising:
an adhesive agent configured to bond the cover to the substrate,
wherein the cover has a smaller width than the substrate.

10. The optical device of claim 8, further comprising:
a guide pattern configured to guide the cover,
wherein an outer end surface of the guide pattern is flush with an outer end surface of the substrate.
